(19) United States
(12) Patent Application Publication
(10) Pub. No.: US 2006/0290033 A1
(43) Pub. Date: Dec. 28, 2006

(54) Blow molding needle

(76) Inventor: Ovidiu Purdel, Pickering (CA)

Correspondence Address: Elias C. Borges, Suite 406, 555 Burnhamthorpe Road, Toronto, ON, M9C 2Y3, CA

(21) Appl. No.: 11/157,931

(22) Filed: Jun. 22, 2005

(51) Int. Cl. B29C 49/60

(52) U.S. Cl. 264/523; 425/536

(57) ABSTRACT

The present invention is a blow molding needle for. blow molding a parison having a hollow center surrounded by walls. The blow molding needle includes an elongated cylindrical hollow tube having opposite first and second ends, the first end of the needle having an open tip. The needle has a straight portion and a tapered parison contact potion for contacting the parison. The contact portion of the needle is located between the open tip and the straight portion. The contact portion of the needle is dimensioned to ensure that only the contact portion contacts the parison. The needle has an outside diameter, the diameter of the tapered portion diminishing along the entire contact portion from the straight portion to the open tip. The tapered portion may be coated with a low friction material such as Teflon™.

### FIELD OF THE INVENTION

The invention relates generally to blow molding needles for blow molding parisons.

### BACKGROUND OF THE INVENTION

Blow molding is a well known method of forming various plastic items such as automobile parts. While there are a variety of blow molding methods available, a commonly used method employs the blowing of a plastic preform or parison in a blow molding chamber. This method often employs a blow molding needle to accomplish the actual blowing of the parison. In this method, a parison is positioned in the blow molding cavity and the blow molding needle is inserted into the parison such that the tip of the blow molding needle penetrates the parison walls and the tip of the blow needle projects into the hollow center of the parison. Air is then blown into the parison through the blow needle to inflate the parison to fill the mold cavity. After the parison is inflated and hardened, the blow needle is withdrawn from the blown item.

There is one problem associated with this method of blow molding. Upon inserting the blow needle, the wall of the parison immediately adjacent the point of insertion is deformed such that the deformed wall portion clings to the portion of the needle projecting into the parisons center. Upon hardening the plastic parison, a portion of hardened plastic remains wrapped around the portion of the blow needle projecting into the parison's center so as to form a “skirt” or sheath around the tip of the blow needle. Withdrawing of the blow needle often results in the skirt or sheath portion of the parison wall breaking off and falling into the center of the blown item. In many cases the hardened plastic residue which falls into the blown plastic item can cause the item to rattle when the item is agitated. The ratteling can be so loud, that in some cases, the molded item must be rejected. This problem may be limited by carefully controlling how the blow molding needle is withdrawn from the blown item, but a permanent solution has remained ellusive.

### SUMMARY OF THE INVENTION

In accordance with the present invention, there is provided a blow molding needle for blow molding a parison having a hollow center surrounded by walls. The blow molding needle includes an elongated cylindrical hollow tube having opposite first and second ends, the first end of the needle having an open tip. The needle has a straight portion and a tapered parison contact potion for contacting the parison. The contact portion of the needle is located between the open tip and the straight portion. The contact portion of the needle is dimensioned to ensure that only the contact portion contacts the parison. The needle has an outside diameter, the diameter of the tapered portion diminishing along the entire contact portion from the straight portion to the open tip.

The present invention is also directed at an improved method of blow molding using the blow needle described above consisting of the steps of providing a parison for blow molding in a mold cavity, the parison having a hollow center surrounded by a wall, and then inserting the blow needle into the parison such that the open tip penetrates the parison wall into the hollow center. The insertion of the blow needle is limited such that only the tappered parison contact portion physically contacts the wall of the parison. The parison is then blown and cooled until it hardens. Finally, the needle is withdrawn from the blown parison after the parison has hardened.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of one end of a blow needle made in accordance with the invention.

FIG. 2. is a cross sectional view of a parison penetrated by the end of the blow needle made in accordance with the present invention.

FIG. 3. is a cross sectional view of a blown and hardened parison showing the blow needle made in accordance with the present invention being withdrawn from the parison.

In the drawings like characters of reference indicate corresponding parts in the different figures.

### DETAILED DESCRIPTION OF THE INVENTION

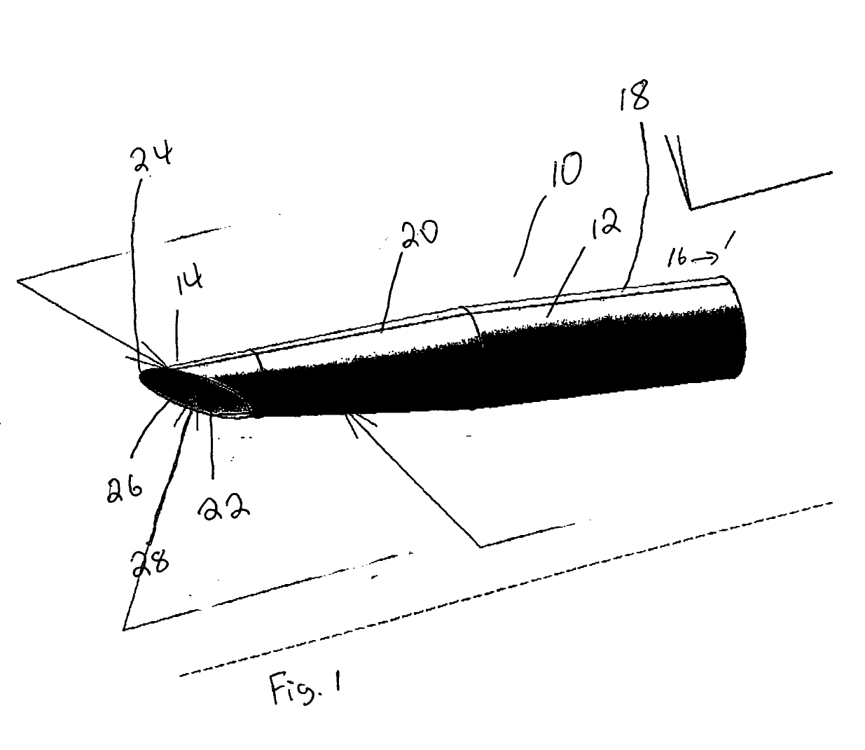

Referring firstly to FIG. 1, a blow needle made in accordance with the present invention consists of blow needle 10 consisting of an elongated hollow tube 12 having opposite ends 14 and 16. Blow needle 10 has a substantially straight portion 18, tapered portion 20 and open tip 22. Open tip 22 is preferably provided with pointed tip 24. Blow needle 10 has blow channel 26 which extends along the entire length of the blow needle and terminated in blow hole 28 on open tip 22. Tapered portion 20 is positioned between straight portion 18 and open tip 22. The outside diameter of tapered portion 20 diminishes along its entire length from the straight portion to the open tip. Blow needle 10 may be made of any material normally used to construct blow needles such as tool steel, titanium or the like.

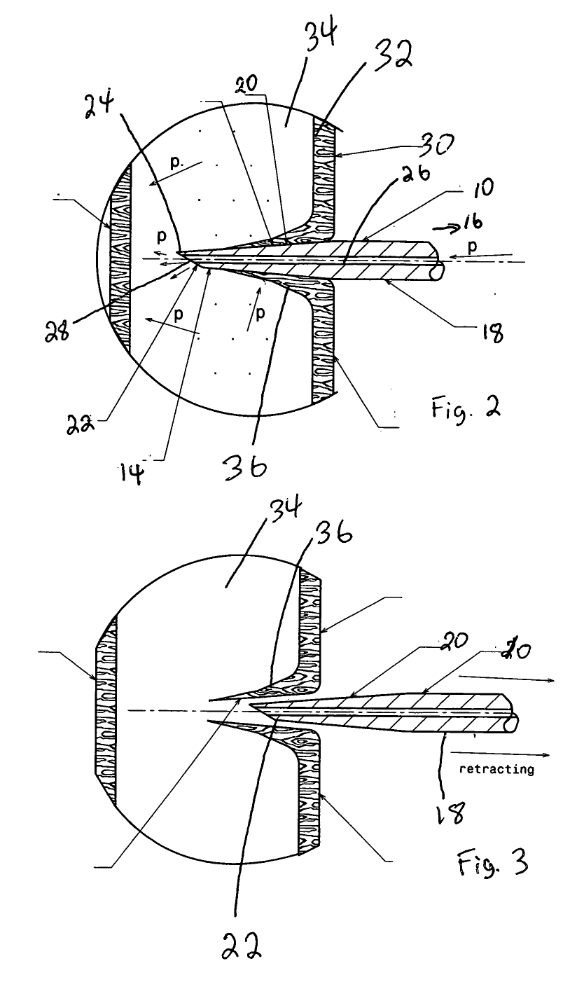

Referring now to FIGS. 2, pointed tip 24 is sufficiently sharp to permit the open tip of the blow needle to easily penetrate parison wall 30 of parison 32. The length of tapered portion 20 is selected such that only the tapered portion of the needle contacts parison 32. In particular, the length of tapered portion 20 is selected such that straight portion 18 never makes contact with wall 30 of parison 32. The length of tapered portion must be carefully tailored to take into consideration the thickness of the parison wall and the depth into which the needle tip 22 must be inserted into the parison. When properly dimensioned, the only part of the needle which the parison will contact when the needle is inserted into the parison is the tapered portion. The pointed tip and tapered portion of blow needle may also be coated with a low friction coating such as Teflon™ to assist in the smooth withdrawal of needle from the hardened parison. The Teflon coating also reduces the amount of cleaning required by the needle.

The method of the present invention will now be discussed with reference to FIGS. 2 and 3. Firstly, parison 30 is provided in a blow molding cavity (not shown). The parison has walls 32 and internal cavity 34. The parison is heated to a softening temperature sufficient to blow the parison. Needle 10 is then inserted into the parison such that open tip 22 is positioned past wall 30 and into cavity 34. The insertion of needle 10 into parison 32 is carefully limited such that the only portion of needle 10 which contacts the parison is tapered portion 20. As the needle is inserted into the parison, the portion of parison wall 30 immediately adjacent the needles point of entry into the parison is drawn inwardly by the needle to form a “skirt” 36 around tappered portion 20. The parison is then blown by forcing air through needle channel 26 and into parison cavity 34. As the parison is blown, it will expand to fill the mold cavity (not shown). The dimensions of the tapered portion of the needle is carefully selected to ensure that as the parison expands upon blowing, only the tappered portion of the needle will contact the parison.

After the parison is fully blown, the parison is cooled sufficiently to harden. After hardening the needle is carefully withdrawn from the parison by retracting the parison. Since the only portion of the needle which contacts the parison is the tappered portion, as the needle is withdawn from the parison, the needle does not drag against skirt 36 formed on parison wall 32. Indeed, almost immediately upon withdrawal of the needle, the tappered portion is separated from skirt 36 by gap 38, thereby decreasing the friction between the parison and the needle to zero. Since the frictional forces created between skirt 36 and tapered portion 20 is reduced to zero almost immediately upon withdrawal of the needle, the chances that a portion of the skirt will break away into cavity 34 is greatly reduced. If the parison contact portion of the needle was not tapered by rather cylindrical, then the skirt would continue to drag against the needle as the needle was withdrawn from the parison. This would result in increased friction between the parison and the needle, resulting in a portion of the skirt breaking off and falling into the cavity of the blown item. The tapered parison contact portion of the blow needle ensures that the skirt does not break off as the needle is withdawn. Furthermore, the fact that the parison contact portion is tapered increases the shear forces exerted by the tip of the blow needle, making for easier and cleaner penetration into the parison.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A blow molding needle for blow molding a parison having a hollow center surrounded by walls, the blow molding needle comprising an elongated cylindrical hollow tube having opposite first and second ends, the first end of the needle having an open tip, the needle having a straight portion and a tapered parison contact potion for contacting the parison, the contact portion being located between the open tip and the straight portion, the contact portion being dimensioned to ensure that only the contact portion contacts the parison, the needle having an outside diameter, the diameter of the tapered portion diminishing along the entire contact portion from the straight portion to the open tip.

2. The blow molding needle of claim 1 wherein the open tip is pointed.

3. The blow molding needle of claim 2 wherein the tapered parison contact portion is at an obtuse angle from the straight portion.

4. The needle of claim 1 wherein the tapered parison contact portion is coated with a low friction coating.

5. The needle of claim 4 wherein the low friction costing consists of a Teflon™ coating.

6. A method of blow molding using the blow needle defined in claim 1 comprising the steps of:
a) providing a parison for blow molding in a mold cavity, the parison having a hollow center surrounded by a wall,
b) inserting the blow needle into the parison such that the open tip penetrates the parison wall into the hollow center, the insertion of the blow needle being limited such that only the tappered parison contact portion physically contacts the parison,
c) blowing the parison and then cooling the blown parison until it hardens,
d) withdrawing the needle from the blown parison after it has hardened.

7. The method of claim 6 wherein the open tip of the needle is pointed.

8. The method of claim 6 wherein the tapered parison contact portion of the needle has a length selected to ensure that only the tapered parison portion of the needle contacts the parison as the parison is blown.

9. The method of claim 6 wherein the tapered parison contact portion is coated with a low friction coating.

10. The method of claim 9 wherein the low friction coating consists of a Teflon™ coating.
